(19) United States
(12) Patent Application Publication
(10) Pub. No.: US 2005/0121828 A1
(43) Pub. Date: Jun. 9, 2005

(54) Fabric woven with flat glass fibers and production method

(75) Inventors: Kazushi Kobue, Sakura Shimo Aza Ipponsugi (JP); Tomofumi Sakai, Sakura Shimo aza Ipponsugi (JP); Yoshiharu Suzuki, Sakura Shimo Aza Ipponsugi (JP); Diego Scari, Brugherio (IT); Marco Scari, Brugherio (IT)

Correspondence Address: BIRCH STEWART KOLASCH & BIRCH, PO BOX 747, FALLS CHURCH, VA, 22040-0747, US

(73) Assignee: Gividi Italia S.p.A, Milano (IT)

(21) Appl. No.: 10/505,589

(22) PCT Filed: Feb. 27, 2003
(86) PCT No.: PCT/IB03/00741

(30) Foreign Application Priority Data
Feb. 28, 2002 (JP) 2002-054470

(51) Int. Cl. B29C 31/00

(52) U.S. Cl. 264/259; 65/437

(57) ABSTRACT

Method of production of glass fabric that does not exhibit surface hairiness, that is sufficiently close-woven, with which printed circuits with a high degree or rigidity can be realized, as well at supply of a glass fabric, prepreg and print circuits. Glass fabric (40) woven from warp yarn (20) and weft yarn (30) containing multiple glass filaments; in relation to the warp yarn (20) and the weft yarn (30), at least one of the two has not undergone twisting and the profile of its glass filament has been flattened. Since between warp yarn (20) and weft yarn (30), at least one of the two has not undergone twisting, it is possible to limit the surface hairiness and at the same time to obtain that the fabrics arm separated and uniformly distributed during the weaving operation also without performing a specific treatment of uniform fibers redistribution. Moreover, since between warp yarn (20) and weft yarn (30), the filament F of at least one of the two has a flattened profile, the spacing between the filaments F is closer, the degree of distribution of the fibers of the glass fabric is higher and the rigidly of the printed circuit laminate is greater.

### FIELD OF THE INVENTION

The present invention relates to a woven glass fabric and to production methods of a woven glass fabric obtained by weaving warp yarns and weft yarns.

### BACKGROUND OF THE INVENTION

Thanks to the rapid developments that have occurred lately in the electronic industry, the printed circuits, that constitute the support on which integrated circuits and semiconductors are mounted, undergo continuous improvements. At the base of the printed circuit, the reinforcement material used for electrical insulation is impregnated with a resin and then left to harden. As reinforcement material, a woven glass fabric is generally chosen with a plain weave construction formed by a weft and a warp made of continuous glass fibers.

With the improvements in the impregnation capabilities of the resins, it has become necessary to implement research efforts in the direction of a greater homogeneity of distribution of the fibers in the woven glass fabric used for the printed circuits. Hence, the best distribution of the spaces between the yarns of the woven fabric is obtained utilizing methods aimed at the uniform redistribution of fibers, such as the treatment with sprays of jets of fluid, or the vibration of a fluid, or moreover with direct pressure. In other words, the goal is to fill the spaces and interstices resulting from the weaving process of the woven fabric to render uniform the woven fabric made of weft and warp yarns, since the yarns may tend to separate during the process.

Up to today, in the known woven glass fabrics the following problems are found: with the introduction of terminals of reduced dimensions, more mobile, and the orientation towards high performance materials, an increasing need for thin glass fabrics has emerged, but in which the interstices are however accurately filled. In the case of thin glass fiber fabrics, executing the uniform redistribution of the fibers with jets of fluid or the vibration of a fluid, the fibers tend to separate and break, and moreover the mesh of the fabric is distorted. Trying to limit said problem of separation of the yarns, it is not possible to reach the goal of uniform redistribution of fibers, and therefore filling the interstices becomes problematic.

In the attempt to obtain thin printed circuits, their rigidity is diminished. Therefore, there is the need to obtain a thinner glass fiber fabric, and at the same time to increase the rigidity of the printed circuits that use woven glass fibers fabric.

The present invention has the goal to provide a production method for a woven glass fiber fabric, in which the phenomenon of surface hairiness does not arise, in which the interstices of the fabric can be filled in a satisfactory way, and with which it is possible to obtain printed circuits with a high rigidity; moreover, the goal of the invention is to provide said woven glass fiber fabric, as well as prepreg and printed circuits.

### DESCRIPTION OF THE INVENTION

In order to obtain the goals listed above, the invention provides a production method for a woven glass fabric made up of warp yarns and weft yarns composed of multiple filaments; said production method being characterized:
By a phase in which the fused glass is spun, conferring to said filaments a flattened profile;
By a phase in which said glass filaments are assembled so as to form a yarn of continuous glass fibers;
By a phase in which said yarn of continuous glass fibers is wound in a way to form a forming cake;
By a phase in which said yarn of continuous glass fibers is used to weave the glass fabric object of the invention, without having to resort to the process of rewinding of said continuous glass fibers yarn previously wound on said forming cake.

Up to now, in the production methods used to make woven glass fabrics, the glass filaments, after having been assembled with an appropriate size so as to form a yarn of continuous fibers, are wound onto a forming cake using a winder. Subsequently, the continuous glass fiber yarn, wound on a forming cake, is rewound on a bobbin and finally used for the production of glass fabrics. Moreover, a process of twisting the continuous glass fibers is generally coupled to the process of rewinding through a winder onto a bobbin.

On the contrary, in the glass fabric production method of the current invention, after the continuous glass fibers have been wound onto a forming cake, these are used in the weaving operation of the glass fiber fabric without having to go through the rewinding process beforehand. Therefore, being able to avoid the rewinding process, in which case the continuous glass fibers are not further twisted, it is then possible to limit the phenomenon of surface hairiness. In the case in which the profile of the glass filament is flattened, since its outer surface is more extensive than a filament with a round profile, the surface hairiness due to the friction between the glass filaments themselves tends to take place more easily. Consequently, the possibility to avoid the rewinding process allows a remarkable limitation of the phenomenon of surface hairiness. Moreover, since the continuous glass fibers are not twisted, the packing strength of the filaments is weaker, and therefore, even without proceeding to an operation of uniform redistribution of the fibers, these separate naturally, resulting in a woven fabric with a high degree of filling of the spaces. Moreover, since the glass filament has a flattened profile, the thickness of the part in which filaments overlap one another is thinner with respect to what happens in the case of filaments with a round profile; consequently, the dimensions of the interstices between filaments inside of the woven fabric are reduced. Therefore, if we compare a glass fiber fabric in which a round profile filament has been used, to another in which a flattened profile filament has been used, assuming that they have the same thickness, the second will provide a greater degree of distribution of the fibers. Consequently, the printed circuits made with glass fiber fabrics obtained according to the method of the present invention have greater rigidity.

Moreover, in relation to the manufacturing method object of the present invention, when a yarn formed by glass fibers with a flattened profile is used only in the weft or only in the warp, it will be characterized by continuous fibers that have not undergone a rewinding process.

In the case in which continuous glass fibers of a flattened profile, that do not need a rewinding process, are only used in the weft or only in the warp, the glass fiber fabric does not exhibit surface hairiness problems and it appears as a close-woven fabric, moreover printed circuits with a high degree of rigidity can be obtained.

Other methods of production of the glass fiber fabric related to the present invention comprise a method of production of a glass fiber fabric in which the weft and the warp consist of a glass yarn with multiple filaments. Said production method is formed by a phase in which the fused glass is spun conferring to said filaments a flattened profile; a phase in which said glass filaments become assembled as to form a continuous glass fiber yarn; a phase in which the continuous glass fiber yarn is wound as to form a forming cake; a phase in which said yarn of continuous glass fibers is woven without having to resort to the process of twisting of the yarn of continuous glass fibers that was previously wound onto a forming cake.

According to the method of production of the glass fiber fabric pertaining to the present invention, the weaving process of the glass fiber fabric is performed without passing through the process of twisting of continuous glass fibers after their winding onto a forming cake. Avoiding in this way the twisting operation of the continuous glass fibers, it is possible to limit the surface hairiness due to the twisting of the continuous glass fibers. In the case in which the profile of the glass filament is flattened, since its surface is more extensive than the one of a filament with a round profile, the surface hairiness due to friction between the glass filaments themselves tends to take place more easily, consequently the possibility to avoid the rewinding process helps remarkably to limit the phenomenon of surface hairiness. Moreover, since the continuous glass fibers are not twisted, the compaction force of the filaments is weaker, therefore even without proceeding to an operation to uniformly redistribute the fibers, these naturally separate during the weaving process, allowing to obtain a good degree of filling of the interstitial spaces. Moreover, since the glass filament has a flattened profile, the thickness of the side where filaments overlap one another, on the shorter side of the profile, is thinner compared to the case of a filament with a round profile; consequently, the dimensions of the interstices between filaments inside of the fabric are reduced. Therefore, if we compare a glass fiber fabric in which a filament with a round profile has been used to one in which a filament with a flattened profile has been used, assuming that they have the same thickness, the latter will possess a greater degree of distribution of the fibers. Consequently, the printed circuits manufactured with a glass fiber fabric obtained according to the method of the present invention possess greater rigidity.

The method of production of the glass fiber fabric pertaining to the present invention is considered appropriate in case the weft or the warp have glass filaments with a flattened cross-section, and in case the continuous glass fibers have not undergone a twisting process.

In the case in which continuous glass fibers with a flattened profile that do not need a rewinding process are used only in the weft yarn or only in the warp yarn, the glass fiber fabric does not exhibit problems of surface hairiness, and a satisfactory degree of filling of the interstitial spaces is obtained, moreover printed circuits are obtained with a high degree of rigidity.

The method of production of the prepreg of the present invention is characterized by the following procedure: a glass fiber fabric obtained following any of the methods of production presented above, is impregnated in a thermosetting resin and is brought to a semi-rigid state.

According to the method of production of the prepreg pertaining to the present invention, using the methods of production presented above; surface hairiness is not found in the continuous glass fibers dipped in the thermosetting resin, the distribution of the fibers is nearly completely uniform, moreover the printed circuits using such prepreg possess comparatively greater rigidity.

The glass fiber fabric of the present invention is a glass fabric composed by a weft and a warp each containing multiple filaments, in which the yarns of at least one of the two components, weft or warp, do not undergo a twisting process, and in which the profile of the filament is given a flattened shape.

In the case of the fabric of the present invention, since the yarn of at least one of the two components, weft or warp, has not undergone a twisting process, allowing in such a way a softer compaction of the fibers, the uniform distribution of the fibers happens naturally, also without proceeding to specific redistribution operation, and a closer-woven fabric is obtained. Moreover, since the yarn of at least one of the two components, weft or warp, has not undergone a twisting process, the problem of the surface hairiness due to the twisting process is limited. In the case in which the profile of the glass filament is flattened, being its surface more extensive than that of a round filament, the surface hairiness due to the friction between glass filaments happens more easily. The fact that the surface hairiness is limited is undoubtedly an advantage. Moreover, since the glass filament has a flattened profile, the thickness of the side in which filaments overlap one another, on the shorter side of the profile, is thinner than what happens in the case of a filament with a round profile; consequently the dimensions of the interstices between filaments inside the fabric are reduced. Therefore, if we compare a glass fiber fabric, in which a filament with a round profile has been used to another in which a filament with a flattened profile has been used, assuming that they have the same thickness, the latter will have a greater degree of distribution of the fibers. This is the reason why a printed circuit produced with the glass fiber fabric described in the present invention exhibits a comparatively greater rigidity.

In the case of the glass fiber fabric of the present invention it is considered adequate that the warp yarn has been twisted and has a summarily round profile, whereas the weft yarn has not been twisted and has a flattened profile.

Since the yarn of at least one of the two components of the fabric, weft or warp, has not undergone a twisting process, the compaction of the fibers is softer, and even without proceeding to a specific fiber redistribution operation, the uniform distribution of fibers happens naturally, allowing to obtain a very close-woven fabric. Moreover, if only the weft yarn is not twisted, the surface hairiness of weft yarn due to twisting can be limited.

The prepreg of the present invention is obtained from said woven glass fiber fabric, which is impregnated by a thermosetting resin. In the prepreg of the present invention, since said fabric is used, the weft yarn inside the thermosetting resin does not exhibit surface hairiness and a nearly regular distribution of the fibers is obtained. It follows that the rigidity of the printed circuits produced with such prepregs is comparatively greater. Such results are even more evident if the weft yarn has not been twisted and if a prepreg is employed in which a filament with flattened section has been used.

The printed circuits of the present invention include the above mentioned glass fiber fabrics as base material. In the case of the printed circuits object of the present invention, since said fabrics are used, the weft yarn does not exhibit surface hairiness, the distribution of the fibers is nearly uniform and the rigidity is comparatively higher.

### DETAILED DESCRIPTION OF THE INVENTION

The invention will now be described in detail, in an exemplifying way, with reference to the attached Figures, in which it must be noted that the same numbers correspond to the same elements.

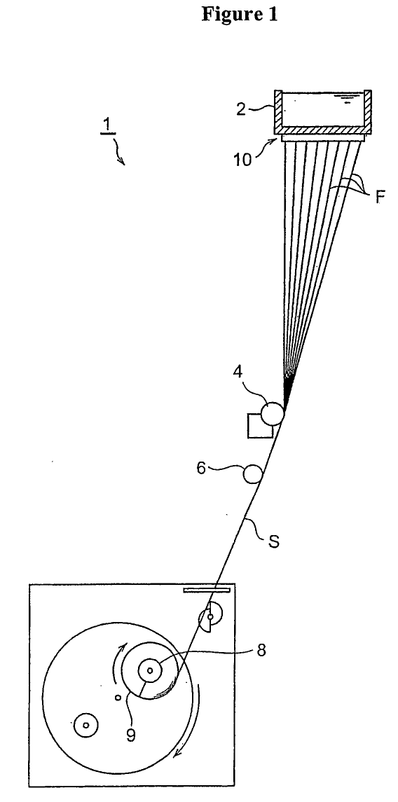

FIG. 1 is a schematic diagram of the structure of the glass fiber production system used to produce continuous glass fibers;

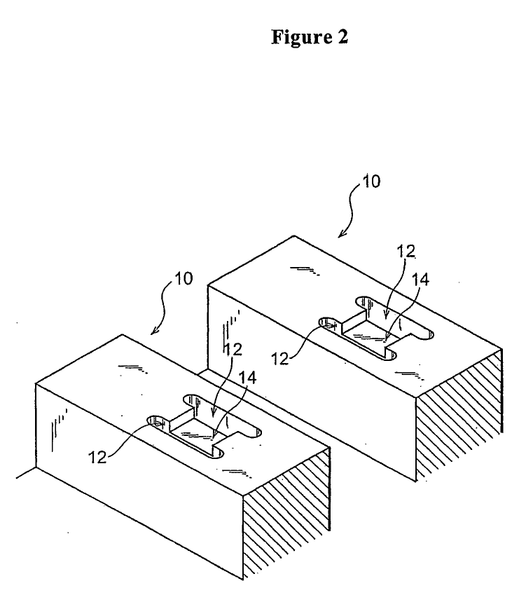

FIG. 2 represents the cross-sectional view, as seen from the bottom, of the bushing employed in the glass fiber production system of FIG. 1;

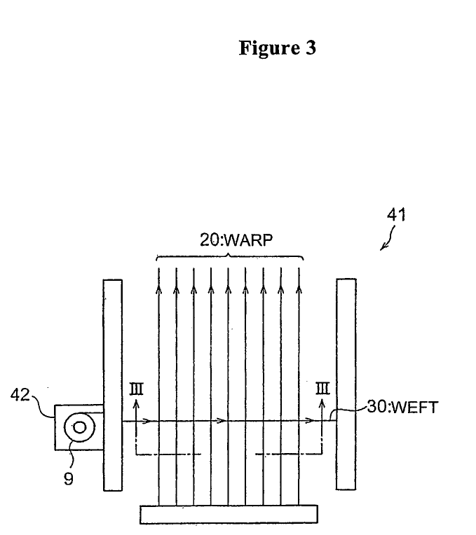

FIG. 3 illustrates an automatic loom;

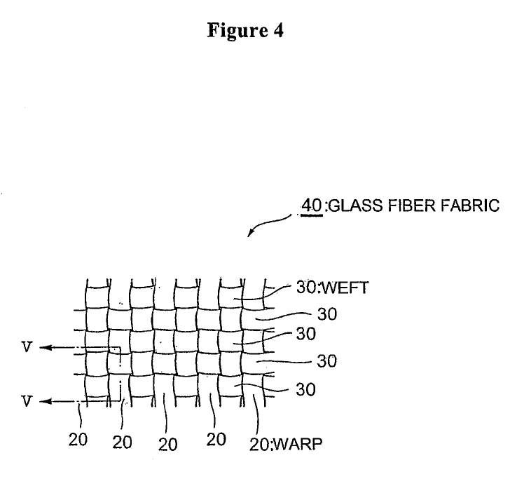

FIG. 4 represents a practical application of the glass fabric object of the present invention;

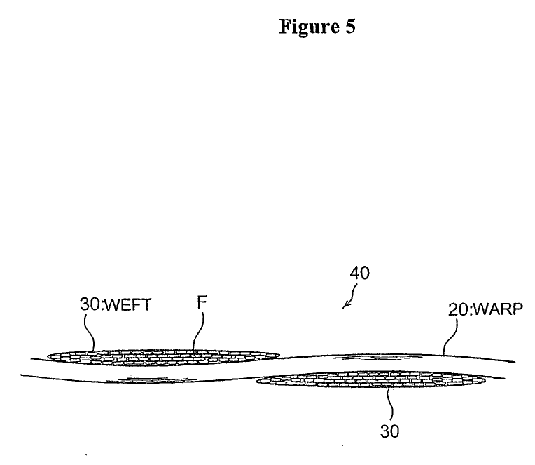

FIG. 5 represents section VV of the glass fabric of FIG. 4;

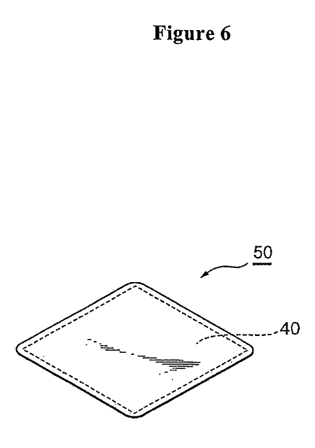

FIG. 6 is a cross-sectional view of a practical application of the prepreg of the present invention;

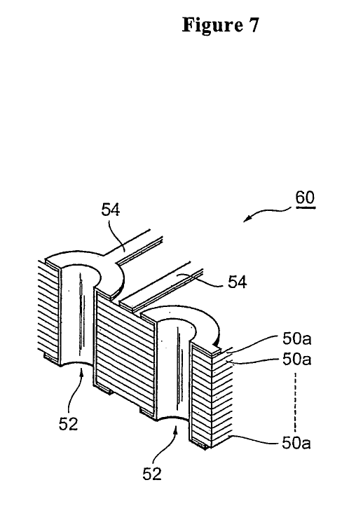

FIG. 7 is a cross-sectional view of a practical application of the printed circuit of the present invention;

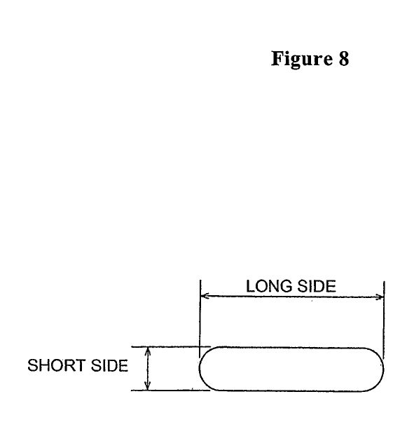

FIG. 8 represents the short and the long side of the filament;

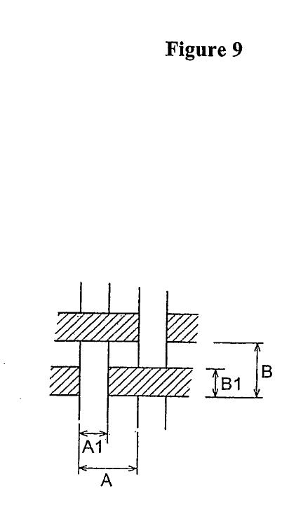

FIG. 9 illustrates the rate of distribution of the fibers of the warp and weft yarn.

Referring to the Figures from 1 to 3 the method of production of the glass fabric of the present invention will be explained. First of all, we will refer to FIGS. 1 and 2 in order to explain the production phases starting from the fused glass until the formation of continuous glass fibers. The first Figure represents in abbreviated form the system 1 of production of glass fibers in order to obtain continuous glass fibers. In the system 1 of the production of glass fibers the bushing 10 is positioned at the base, while a crucible 2 is placed in which the fused glass is fed; the fused glass, that comes out from the holes of bushing 10, after having been cooled, becomes the filament F.

FIG. 2 is a diagonal view from the bottom side. In the bushing 10, a flattened shape has been given to holes 12. Moreover, two holes 12 constitute a couple, and between every couple of holes 12 there is a rectangular-shaped socket 14 for the separation of filaments. The fused glass that comes out from each hole 12 is moulded according to the shape of the holes 12, it exhibits a flattened profile and is cooled as it contacts the air present in the unit of separation 14. The fused glass with a flattened profile increases its own viscosity and it solidifies even before decreasing the degree of flattening due to the surface tension, creating in this way the glass filament of flattened profile F.

The production process of glass fibers will be illustrated with reference to FIG. 1. Under the bushing 10 a roller 4 is placed to apply the binder. Thanks to said roller 4 used for the binder application, this binder is applied on the glass filament F, which, under the effect of the joining cylinder 6 is assembled and formed in yarn; in this way the continuous glass fiber S is obtained. In a continuous glass fiber S, for example, are contained between 50 and 400 glass filaments F. Subsequently, the yarn is wound in a cylindrical or conical shape with the winder 8, and takes the form of a forming cake 9. But it must be noted that at the state of forming cake 9, the continuous glass fiber has not undergone twisting.

Below we will be examining the automatic loom 41 of FIG. 3 and explain the weaving process of the glass fabric. First of all, the forming cake of the continuous glass fibers 9 obtained as explained above, is positioned “as is” in the weft feeder 42. This means that, as far as the weft yarn, the rewinding operation onto a bobbin is not performed as it has been performed up to today. Since the rewinding operation is not performed starting from the forming cake 9, therefore the continuous glass fibers are not twisted. As far as the warp yarn, in the present application the profile of the filament is roughly round and the continuous glass fibers have been rewound from forming cake to bobbin. However as far as warp yarn (not the weft yarn), a filament with a flattened profile can be used that has not been rewound from the forming cake.

After having loaded on the automatic loom 41 the weft yarn and warp yarn made of continuous fibers, the loom 41 is started and the multiple yarns of warp yarn 20 are inserted in the same direction with a uniform spacing, while the weft yarn 30 is inserted in such a way to cross the warp yarn at a 90 degree angle. In this way glass fiber fabric is obtained with a plain weave construction.

FIG. 4 is a depiction of the glass fiber fabric 40 thus obtained, while FIG. 5 is the relative cross-section in the VV direction of FIG. 4. It is noted that FIG. 5 is a cross-section that follows the line that marks half of the width of warp yarn 20 (right-left direction in FIG. 4). As it is illustrated in each of the Figures, warp yarn 20 and weft yarn 30 cross each other overpassing one another, alternatively.

As described above, as far as the fabrication of the glass fiber fabric 40, the continuous glass fiber S, after having been wound in a cylindrical shape onto forming cake 9, is then woven in the glass fabric 40 without undergoing any rewinding operation onto a bobbin, that is without imposing to the continuous glass fiber S a further twisting process. If the rewinding process of the continuous fibers is avoided (twisting process), and continuous glass fibers S (weft yarn 30) do not undergo twisting, it is possible to limit the surface hairiness. Moreover, since the weft yarn has not undergone twisting, its degree of compaction is weaker; that allows to obtain a uniform distribution of the fibers in a natural way with the force exercised by the warp yarn 20, without having to perform a specific separate operation with the goal of obtaining a uniform distribution of the fibers. Moreover, even if the filament is not distributed in an uniform way, when the force of the warp yarn is exercised, since the secondary moment for the glass fiber filament with a flattened profile is greater and since also the rotation radius is greater, the filament tends to position itself in the direction of the short side, therefore resulting in a thin yarn with a wide surface.

Moreover, also in the case in which any treatment for the uniform redistribution of fibers is applied to the glass fibers fabric 40, such as a spray of jets of liquid or the vibration of a liquid, inasmuch as the continuous glass fiber S has not undergone any twisting operation and therefore its degree of compaction is weak, a satisfactory uniform redistribution of the fibers is obtained even if the energy applied to the glass fiber fabric 40 at the moment of the operation of fibers redistribution is smaller. The result is a close-woven glass fiber fabric 40 and at the same time a limited surface hairiness. As examples of energy used during the operation of uniform redistribution of fibers, we can mention the speed or the power of the jet of liquid in the case of a spray operation, or the frequency of vibration in case of a treatment with vibration of a liquid. It is possible to set the speed of such treatments so as to vary the degree of distribution of the fibers.

Being the glass filament F that constitutes the weft yarn 30 of flattened profile, at the moment of the weaving process the various glass filaments F are inserted with their length positioned horizontally as evidenced in FIG. 5. Moreover, since the profile of the filament F is flattened, the interstices between the contiguous filaments F are of smaller dimensions, that is, the filaments F are closer between themselves. Moreover, the thickness of the glass fabric 40 is thinner in the direction in which the short sides of the section of filaments F are overlapped (top-bottom direction in FIG. 5).

With reference to FIGS. 6 and 7, explanations are now given about the prepreg and the printed circuits in which the glass fiber fabric 40 is used. FIG. 6 is an oblique view of prepreg 50 manufactured with the glass fiber fabric 40 of the present practical application, while FIG. 7 represents printed circuit 60 manufactured with prepreg 50 as base material. For prepreg 50, after having impregnated the glass fabric 40 with thermosetting resin that has a resin-matrix function, a drying treatment is applied after which prepreg 50 will be in a semi-rigid state. As far as the resin-matrix, practically epoxy resins, non-saturated polyester resins and polyimide resins and other similar resins are used.

Printed circuit (PWB: Printed Wiring Board) 60 formed with prepreg 50 as base material can be obtained as described below. At first, several prepregs are overlapped on each other and, using pressure and heat, a multilayer laminate is obtained. To the laminate that has undergone a pressure and temperature treatment is attributed 50a. On both sides (or also on a single side) of the multilayer laminate a copper sheet is applied and a copper clad laminate is obtained (CCL: Copper Clad Laminate). Following a method such as the so called “subtractive” method, line 54 is shaped, which constitutes the printed circuit. In this way the printed circuit 60 is completed as it is represented in FIG. 7. However, the printed circuits of the present invention are not limited to what is depicted in FIG. 7, as a large number of variations are possible. As an example, instead of limiting the printed circuit to the external surface, it can be realized also in the inner layers, thus obtaining multilayer printed circuits (ML-PWB: Multilayer Printed Wiring Board).

Said prepreg 50 comprises the glass fabric 40 impregnated in the thermosetting resin; said glass fabric 40 exhibits weft yarn of uniform distribution and without surface hairiness. This is the reason why the printed circuit 60 made with said prepreg 50 is of homogenous rigidity in all points. Moreover, as already explained previously, since the profile of the filament F is flattened, the position of the filaments F inside the prepreg 50 is very close; this confers greater rigidity to printed circuit 60, which takes advantage of the prepreg 50 for its fabrication. Based on such premises, it is possible to obtain a thin printed circuit 60, but with a high degree of rigidity.

In the present practical application, the continuous glass fiber S obtained from the glass fiber filament of flattened profile F that has not undergone the rewinding twisting operation, is not used in the warp yarn and in the weft yarn at the same time, but only in the weft yarn. However, also in such circumstances it is possible to limit the surface hairiness at the moment of the uniform redistribution of the fibers and obtain a close-woven fabric in a satisfactory way, and also a printed circuit 60 with high rigidity. However, differently from the present practical application, in which the continuous glass fiber S that has been obtained from the filament F and that has not undergone the rewinding and twisting process is used only in the weft 20, it is anyway possible to use said continuous glass fiber S only in warp 30. Obviously, it is also possible to use the continuous glass fiber S that has been obtained from the filament F that has not undergone the rewinding and twisting process both for warp 20 and for weft 30.

Examples of Practical Applications

Below, based on practical applications, the results of the present invention will be examined more concretely.

As evidenced in Table 1, in the example of practical application 1, the warp yarn ECE225 is formed by a round glass filament of 7 μm diameter, and the weft yarn is formed by a glass, filament with a flattened profile whose short side is of 4.5 μm and long side of 18 μm. The long and short sides express the length depicted in FIG. 8. Since the warp yarn has been rewound on bobbin, after having been spun and wound on a forming cake, it possesses a twist of 1.0 turns/25 mm. The weft yarn instead, not being rewound, has not undergone any twisting operation. On the glass fabric formed by such weft and warp, no operation has been performed for the uniform redistribution of the fibers.

TABLE 1

| | | | Example of | | |
|---|---|---|---|---|---|
| | | | practical | Comparative | Comparative |
| | | | application 1 | example 1 | example 2 |
| Continuous | Filament | Warp | 7 | 7 | 7 |
| glass | Diameter | Weft | Short side 4.5 | Short side 4.5 | 9 |
| fibers | (μm) | | Long Side 18 | Long Side 18 | |
| yarns | | | (flattened | (flattened | |
| | | | profile) | profile) | |
| | Yarn Count | Warp | 22.5 | 22.5 | 22.5 |
| | | Weft | 33.7 | 33.7 | 33.7 |
| | Torsion | Warp | 0.7 Z | 0.7 Z | 0.7 Z |
| | (turns/25 mm) | | | | |
| | | Weft | 0 Z (no | 1.0 Z | 0 Z (no |
| | | | rewinding) | | rewinding) |

| | | |
|---|---|---|
| Density of the fabric | Warp | 40 |
| (yarns/25 mm) | Weft | 39 |

| Air permeability (cm³/cm²/s) | 41.1 | 119.6 | 132.9 |
|---|---|---|---|
| Unit weight (g/cm²) | 88.1 | | |
| Thickness (millimeter) | 0.082 | 0.09 | 0.093 |
| Fabric degree of impregnation (%) | 41.3 | 37.7 | 36.4 |

Having carried out the measurement of air permeability of this glass fabric in a conforming apparatus (JIS R 3420), a relatively low value of 41.1 cm³/cm²/s is resulted. That means that even if no operation of uniform redistribution of the fibers has been performed, the glass fabric of practical application 1 exhibits a low air permeability and a closed weave. That is because the weft yarn with a flattened profile has not been twisted, because its degree of compaction is low and because the uniform distribution of the fibers has happened in a natural way in the weaving phase. It is noted however that the glass fabric, after having been impregnated in the resin, reaches a degree of impregnation of the glass fibers of 41.3% inside of the hardened multilayer. Moreover, by examination of the surface of the glass fabric, no surface hairiness of the weft yarn is found. This is due to the fact that it was possible to avoid the twisting operation.

After having measured the degree of air permeability, the treatment of uniform redistribution of the fibers of the glass fabric of the practical application 1 with a liquid (water) was performed. The glass fabric that before the operation of uniform redistribution of the fibers had a degree of distribution of the fibers of the warp yarn of 49.7%, and a degree of distribution of the fibers of the weft yarn of 95.9%, with an air permeability of 41.1 cm³/cm²/s, has exhibited a degree of distribution of the fibers of the warp yarn of 81.6% and a degree of distribution of the fibers of the weft yarn of 97.6%, with an air permeability of 13.2 cm³/cm²/s. By examination of the surface of the glass fabric after the uniform redistribution of the fibers, almost no sign of surface hairiness has been found. Moreover, these results allow to underline that, in the case of the glass fabric of the current example of practical application, the uniform redistribution of the fibers is obtained more easily for the warp yarn than for the weft yarn. The degree of distribution of the fibers of the warp yarn and of the weft yarn, with reference to FIG. 9, has been calculated in the following way:
degree of distribution of the fibers of the warp yarn=A1/A×100 (%) degree of distribution of the fibers of the weft yarn=B1/B×100 (%)
A=warp yarn spacing
A1=width of the warp yarn
B=weft yarn spacing
B1=width of the weft yarn.

In the glass fabric of comparative example 1, for warp yarn and weft yarn the same yarn of the example of practical application 1 has been used. The part in which the comparative example diverges from the example of practical application 1 is the following: before weaving, the weft yarn is rewound on a bobbin with a torsion of 1.0 turns/25 mm. As in the example of practical application 1, the measurement of air permeability of this glass fabric has been carried out in a conforming apparatus (JIS R 3420) and the result is 119.6 cm³/cm²/s. This result shows that the glass fabric of comparative example 1, with respect to the one of the example of practical application 1, is less close-woven. This is due to the fact that the weft yarn with a flattened profile has been twisted, the degree of compaction of the fibers is high, and therefore the weft yarn does not widen easily during weaving. Moreover, since in comparative example 1 the rewinding of the weft yarn has been performed, we observe a substantial surface hairiness of the weft yarn of the glass fabric.

Differently from the example of practical application 1, for the glass fabric of comparative example 2 a glass filament of round profile (diameter 9 μm) has been used. However, as in the example of practical application 1, the weft yarn has not been rewound from the forming cake to the bobbin and no twisting operation has been performed. As in the example of practical application 1, the measurement of air permeability of said glass fabric has been performed in a conforming apparatus (JIS R 3420) and the result is. 132.9 cm³/cm²/s. This result shows that the glass fabric of comparative example 2, with respect to the one of the example of practical application 1, is less close-woven. In this way it is evident that simply not performing the twisting of the weft or warp yarn is not enough to increase the uniform distribution of the fibers. The improvement of the degree of uniform distribution of the fibers is connected to the use of a filament with a flattened profile for the continuous glass fibers, and to the lack of twisting.

1. Method for the preparation of a glass fabric comprising weft yarns and warp yarns containing multiple filaments of glass, which method comprises:
a phase in which the fused glass is spun to form said filaments with a flattened section;
a phase in which said glass filaments are assembled so as to form a continuous glass fiber yarn;
a phase in which said yarn of continuous glass fibers is wound so as to form a forming cake;
a phase in which said yarn of continuous glass fibers is used to weave said glass fabric object of the invention without having to resort to the process of rewinding said glass yarn of continuous fibers previously wound on said forming cake.

2. Method to produce a glass fabric woven according to claim 1, in which said fabric is comprised of said warp and said weft, whose glass filaments are characterized by said flattened section, and which fabric is moreover characterized by being formed by said continuous glass fibers that do not need a rewinding process.

3. Method for the preparation of a glass fabric in which the weft and the warp consist of a glass yarn of multiple filaments, comprising the following phases:
spinning the fused glass conferring to said filaments a flattened section;
assembling said glass filaments in a way as to form a continuous glass fiber yarn;
winding said yarn of continuous glass fibers as to form a forming cake;
using said yarn of continuous glass fibers without further twisting to weave the glass fabric, without having to resort to the process of twisting of said yarn of continuous glass fibers previously wound on said forming cake.

4. Method according to claim 3, in which said fabric is comprised of said warp and said weft, whose glass filaments are characterized by said flat cross-section, and which fabric is moreover characterized by being composed of said continuous glass fibers that do not need the said process of further twisting.

5. Method for the preparation of a prepreg, characterized in that it is formed with a glass fabric obtained according to one of the methods cited in claims 1 to 4, and brought to a semi-rigid state through impregnation in a thermosetting resin bath and subsequent drying.

6. Glass fabric in which said weft and said warp contain multiple glass filaments and in which the filaments of at least one of the two components, weft or warp, has not been twisted, and in which the cross-section of the glass filament is moreover characterized by being flat.

7. Glass fabric according to claim 6, characterized in that while said warp yarn has undergone twisting and the cross-section of said glass filament is roughly round, said weft yarn has not undergone twisting and said filament has a flat cross-section.

8. Prepreg characterized in that it is obtained by the impregnation of the glass fabric described in claims 6 or 7 in a thermosetting resin bath.

9. Printed circuit characterized in that it contains as base material the glass fabric mentioned in claims 6 or 7.
